(19) United States
(12) Patent Application Publication
(10) Pub. No.: US 2017/0023198 A1
(43) Pub. Date: Jan. 26, 2017

(54) VEHICLE HEADLIGHT

(71) Applicant: Chen-Wei HSU, Tainan (TW)

(72) Inventor: Chen-Wei HSU, Tainan (TW)

(21) Appl. No.: 14/805,480

(22) Filed: Jul. 22, 2015

(51) Int. Cl. F21S 8/10

(52) U.S. Cl. CPC F21S 48/115; F21S 48/1225

(57) ABSTRACT

A vehicle headlight includes a base with a separation plate located therein. The base is composed of a first part and a second part to form the arched reflector. Multiple fins are formed on the rear end of the separation plate and located outside of the base. Each of the top face and the bottom face of the separation plate has multiple Light Emitting Diodes (LEDs) connected thereon. A shading plate is located at the front of the first part and has a notch defined in the top thereof. A driving device is connected to the shading plate and drives a movable plate to movably seal the notch. The light beams generated from the LEDs are reflected by the reflectors, and the heat is brought away by the fins.

### BACKGROUND OF THE INVENTION

1. Fields of the Invention

The present invention relates to a vehicle headlight, and more particularly, to a vehicle headlight which includes Light Emitting Diodes (LEDs) on the separation plate in the base so as to generate even light beams to provide better illumination feature.

2. Descriptions of Related Art

The conventional vehicle headlight 1 generally has a feature to switch between the high beam and the low beam according to the practical needs on the roads. As disclosed in FIGS. 1 and 2, the headlight 1 has a base 10 in which a room 100 is defined. The room 100 is defined by an arched reflector 101 and a light source 11 is located within the room 100. The light source 11 can be a Xenon light bulb, LEDs, or a Tungsten filament light bulb. A plate 12 is located at the front of the base 10 and has a hole 120. A connection member 13 is located at the front of the plate 12 and has a shading unit 14 received therein which has an electro-magnetic valve 140 and a shading plate 141. A lens 15 is connected to the front of the connection member 13 by a frame 16. The light beams 17 generated from the light source 11 are reflected by the reflector 101 and then pass through the lens 15. The shading unit 14 is used to control the range and angle of the light beams 17 so as to form the high beam and the low beam. However, the light beams 17 become random and are not controlled when being reflected by the reflector 101. The illumination feature is not satisfied and the light is not even. Besides, the light source 11 in the base 10 generates significant heat which is trapped in the base 10 and may damage the light source 11 and the related circuits to shorten the life of use of the headlight. The present invention intends to provide a vehicle headlight to eliminate the shortcomings mentioned above.

### SUMMARY OF THE INVENTION

The present invention relates to a vehicle headlight and comprises a base composed of a first part and a second part. Each of the first and second parts has a facing side, a front end and a rear end. The first and second parts are connected to each other by the two respective facing sides so as to form an arched reflector in the base. A separation plate is located between the first and second parts. Multiple fins are formed on the rear end of the separation plate and located outside of the first and second parts. A circuit board is connected to each of the top face and the bottom face of the separation plate. Each circuit board has multiple Light Emitting Diodes (LEDs) connected thereon. A shading plate is located at the front of the first part and has a notch defined in the top thereof. A driving device is connected to the shading plate and has a movable plate which is movable to seal the notch of the shading plate. A fixing mount is connected to the front of the base, and a lens is connected to the fixing mount.

Preferably, the first part and the second part each have a first flange extending from the front end thereof. Each of the first flanges has multiple holes. The shading plate has multiple holes which are located in alignment with the holes of the first flange of the first part. The fixing mount has multiple lugs and each lug has a hole. A portion of the holes of the lugs of the fixing mount are located corresponding to the holes of the first flange of the first part and the holes of the shading plate. The rest portion of the holes of the lugs of the fixing mount are located corresponding to the holes of the first flange of the second part. Bolts extend through the alignment holes of the lugs of the fixing mount, the holes of the shading plate, and the holes of the first flange of the first part. Bolts extend through the alignment holes of the lugs of the fixing mount and the holes of the first flange of the second part.

Preferably, the first part and the second part each have a second flange extending from the facing side thereof. Each of the second flanges has multiple holes. The separation plate has multiple holes which are located in alignment with the holes of the second flanges of the first and second parts. Bolts extend through the alignment holes of the second flanges of the first and second parts and the holes of the separation plate.

Preferably, the driving device has an electro-magnetic valve which has a shaft and a spring is mounted to the shaft. The shaft is connected with a link which is connected with a movable plate. The movable plate is movably connected to the shading plate so as to movably seal the notch of the shading plate.

The primary object of the present invention is to provide a vehicle headlight wherein the separation plate has LEDs on both top face and bottom face so that the light beams generated from the LEDs are evenly reflected by the reflectors and then refracted so that the vehicle headlight of the present invention provide even light and better illumination. The heat generated by the LEDs on the separation plate can be quickly brought away by the fins to keep the vehicle headlight to work at appropriate temperature.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view to show the conventional vehicle headlight, wherein the low beam is operated;

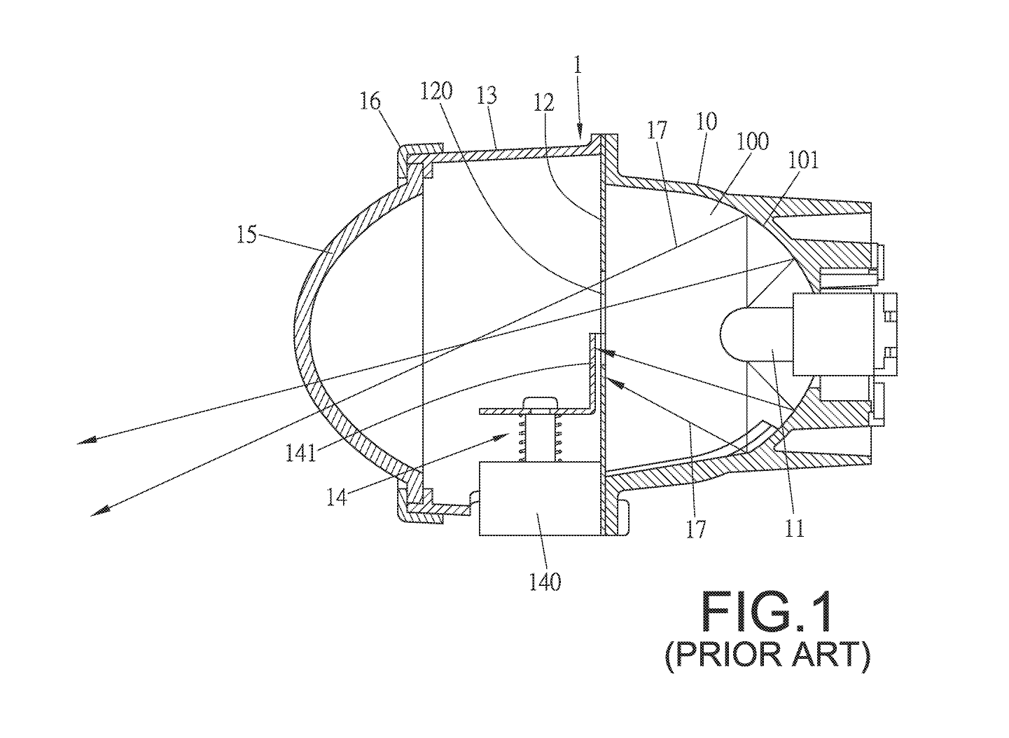

FIG. 2 is a cross sectional view to show the conventional vehicle headlight, wherein the high beam is operated;

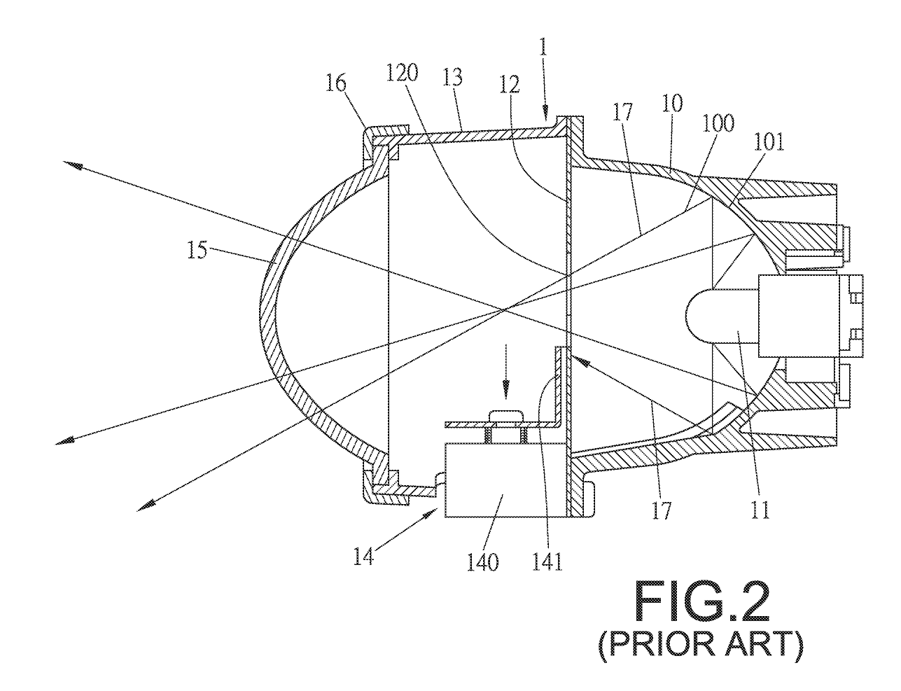

FIG. 3 is an exploded view of the vehicle headlight of the present invention;

FIG. 4 is a perspective view to show the vehicle headlight of the present invention;

FIG. 5 is a cross sectional view to show the vehicle headlight of the present invention, wherein the low beam is operated, and

FIG. 6 is a cross sectional view to show the vehicle headlight of the present invention, wherein the high beam is operated.

### DETAILED DESCRIPTION OF THE PREFERRED EMBODIMENT

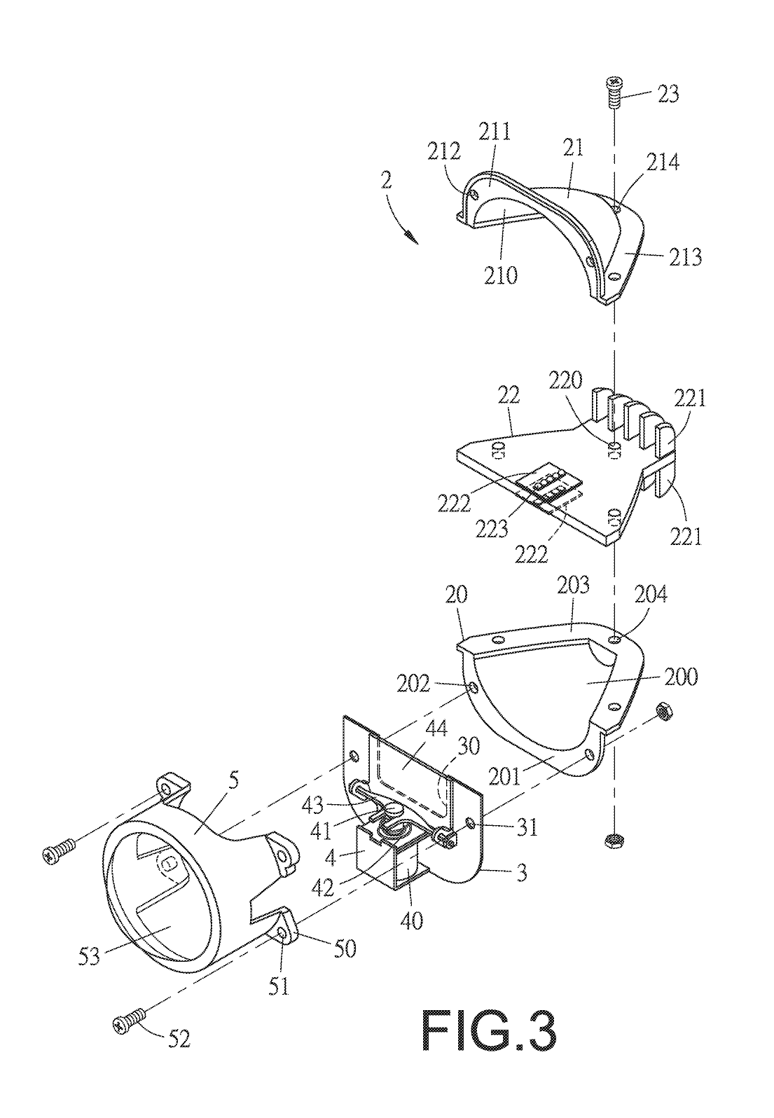

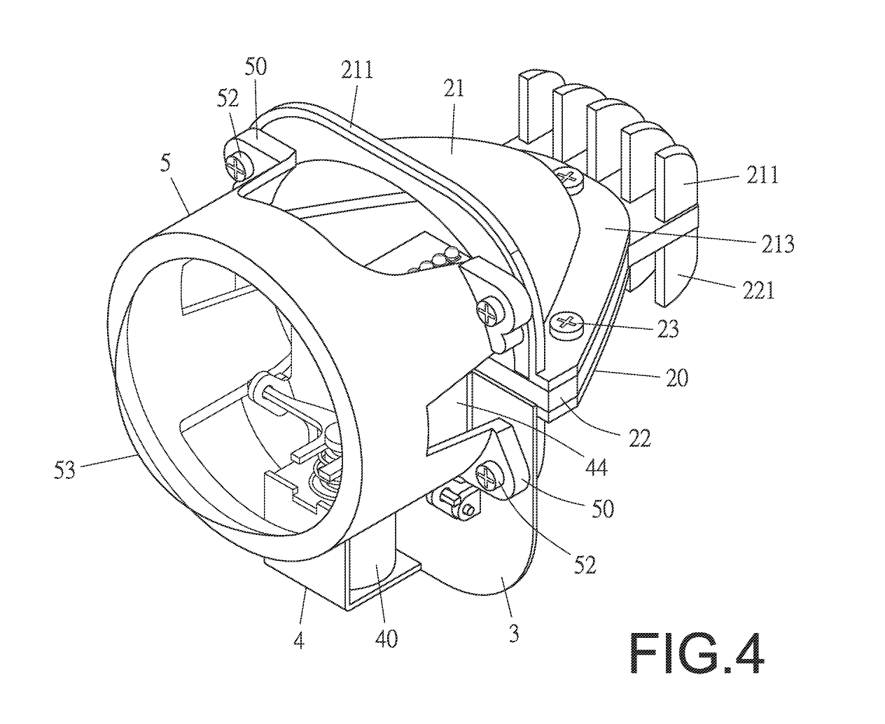

Referring to FIGS. 3 to 5, the vehicle headlight of the present invention comprises a base 2 which is composed of a first part 20 and a second part 21. Each of the first and second parts 20, 21 has a facing side, a front end and a rear end. The first and second parts 20, 21 each have a reflector 200/210. The first and second parts 20, 21 are connected to each other by the two respective facing sides, an arched reflection surface is constituted by the two reflectors 200, 210 in the base 2. A separation plate 22 is located between the first and second parts 20, 21. Multiple fins 221 are formed on the rear end of the separation plate 22 and located outside of the first and second parts 20, 21. A circuit board 222 is connected to each of the top face and the bottom face of the separation plate 22, and each circuit board 222 has multiple Light Emitting Diodes (LEDs) 223 connected thereon.

A shading plate 3 is located at the front of the first part 20 and has a notch 30 defined in the top thereof. A driving device 4 is connected to the shading plate 3 and has a movable plate 44 which is movable to seal the notch 30 of the shading plate 3.

The first part 20 and the second part 21 each have a first flange 201/211 extending from the front end thereof. Each of the first flanges 201, 211 has multiple holes 202/212. The shading plate 3 has multiple holes 31 which are located in alignment with the holes 202 of the first flange 201 of the first part 20. The fixing mount 5 has four extensions and each extension has a lug 50 formed on the distal end thereof. Each lug 50 has a hole 51. The first part. 20 and the second part 21 each have a second flange 203/213 extending from the facing side thereof. Each of the second flanges 203, 213 has multiple holes 204/214. The separation plate 22 has multiple holes 220 which are located in alignment with the holes 204, 214 of the second flanges 203, 213 of the first and second parts 20, 21.

When assembling the vehicle headlight, the holes 51 of the two lugs 50 of the fixing mount 5 are located corresponding to the holes 202 of the first flange 201 of the first part 20 and the holes 31 of the shading plate 3. The holes 51 of the other two lugs 50 of the fixing mount 5 are located corresponding to the holes 212 of the first flange 211 of the second part 21. Two bolts 52 extend through the alignment holes 51 of the lugs 50 of the fixing mount 5, the holes 31 of the shading plate 3, and the holes 202 of the first flange 201 of the first part 20. Another two bolts 52 extend through the alignment holes 51 of the lugs 50 of the fixing mount 5 and the holes 212 of the first flange 201 of the second part 21. Therefore, the fixing mount 5, the shading plate 3 and the base 2 are connected. For the connection of the separation plate 22 and the base 2, multiple bolts 23 extend through the alignment holes 204, 214 of the second flanges 203, 213 of the first and second parts 20, 21 and the holes 220 of the separation plate 22. The fixing mount 5 is therefore connected to the front of the base 2, and a lens 53 is connected to the fixing mount 5.

The driving device 4 has an electro-magnetic valve 40 which has a shaft 41 and a spring 42 is mounted to the shaft 41. The shaft 41 is connected with a link 43 which is connected with a movable plate 44. The movable plate 44 is movably connected to the shading plate 3 so as to movably seal the notch 30 of the shading plate 3.

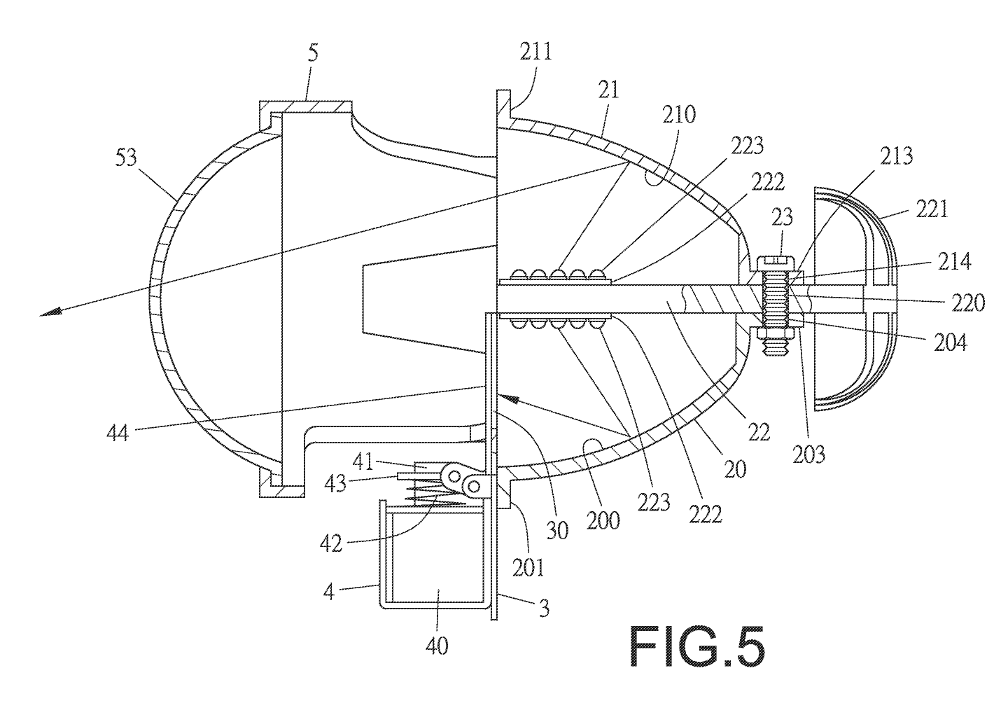

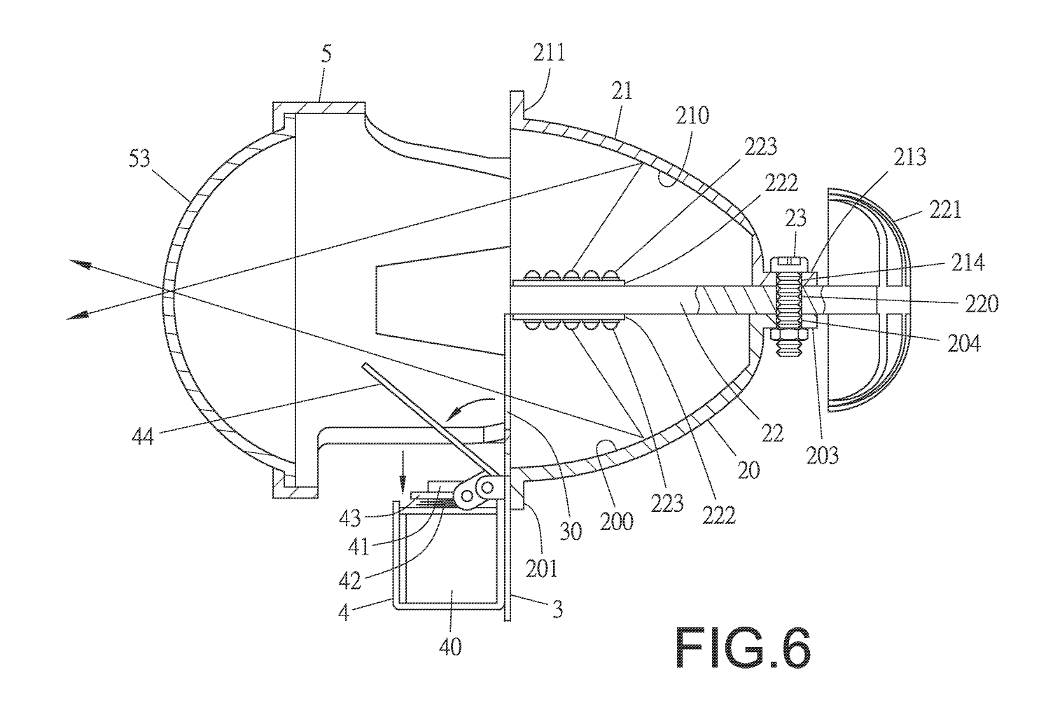

As shown in FIGS. 5 and 6, when the rider wants to use the high beam, the electromagnetic valve 40 is operated, the electro-magnetic valve 40 generates a force to move the shaft 41 to retract downward and the link 43 also moves downward, and the spring 42 is compressed. When the link 43 moves downward, the movable plate 44 is also moved downward and does not seal the notch 30 as shown in FIG. 6. Therefore, the light beams from the LEDs 223 on the top face and the bottom face of the separation plate 22 are reflected by the arched reflection surface constituted by the two reflectors 200, 210 and pass through the lens 53 so as to form the high beam.

When the rider wants to use the low beam, the electro-magnetic valve 40 is disabled, the spring 42 bounces back, and both of the shaft 41 and the link 43 move upward. The link 43 moves upward and drives the movable plate 44 to move upward to seal the notch 30 as shown in FIG. 5. Therefore, the light beams from the LEDs 223 on the bottom face of the separation plate 22 are blocked by the movable plate 44 and cannot pass through the lens 53. The light beams from the LEDs 223 on the top face of the separation plate 22 are reflected by the arched reflectors 210 200 and pass through the lens 53 so as to form the low beam.

The light beams generated from the LEDs 223 on both top face and bottom face of the separation plate 22 are evenly reflected by the reflectors and then refracted so that the vehicle headlight of the present invention provide even light and better illumination. The heat generated by the LEDs 223 on the separation plate 22 are conducted to the fins 221 and can be quickly brought away to keep the vehicle headlight to work at appropriate temperature.

While we have shown and described the embodiment in accordance with the present invention, it should be clear to those skilled in the art that further embodiments may be made without departing from the scope of the present invention.

What is claimed is:

1. A vehicle headlight comprising:
a base composed of a first part and a second part, each of the first and second parts having a facing side, a front end and a rear end, the first and second parts connected to each other by the two respective facing sides so as to form an arched reflector in the base, a separation plate located between the first and second parts, multiple fins formed on a rear end of the separation plate and located outside of the first and second parts, a circuit board connected to each of a top face and a bottom face of the separation plate, each circuit board having multiple Light Emitting Diodes (LEDs) connected thereon;
a shading plate located at a front of the first part and having a notch defined in a top thereof;
a driving device connected to the shading plate and having a movable plate which is movable to seal the notch of the shading plate, and
a fixing mount connected to the front of the base, a lens connected to the fixing mount.

2. The vehicle headlight as claimed in claim 1, wherein the first part and the second part each have a first flange extending from the front end thereof, each of the first flanges has multiple holes, the shading plate has multiple holes which are located in alignment with the holes of the first flange of the first part, the fixing mount has multiple lugs and each lug has a hole, a portion of the holes of the lugs of the fixing mount are located corresponding to the holes of the first flange of the first part and the holes of the shading plate, the rest portion of the holes of the lugs of the fixing mount are located corresponding to the holes of the first flange of the second part, bolts extend through the alignment holes of the lugs of the fixing mount, the holes of the shading plate, and the holes of the first flange of the first part, bolts extend through the alignment holes of the lugs of the fixing mount and the holes of the first flange of the second part.

3. The vehicle headlight as claimed in claim 1, wherein the first part and the second part each have a second flange extending from the facing side thereof, each of the second flanges has multiple holes, the separation plate has multiple holes which are located in alignment with the holes of the second flanges of the first and second parts, bolts extend through the alignment holes of the second flanges of the first and second parts and the holes of the separation plate.

4. The vehicle headlight as claimed in claim 1, wherein the driving device has an electro-magnetic valve which has a shaft and a spring is mounted to the shaft, the shaft is connected with a link which is connected with a movable plate, the movable plate is movably connected to the shading plate so as to movably seal the notch of the shading plate.
